(19) United States
(12) Patent Application Publication
(10) Pub. No.: US 2015/0266527 A1
(43) Pub. Date: Sep. 24, 2015

(54) LINK FOR TRACK ASSEMBLY

(71) Applicant: Caterpillar Inc., Peoria, IL (US)

(72) Inventors: Temitope O. Akinlua, Peoria, IL (US); David J. Hakes, Brimfield, IL (US); Daniel I. Knobloch, Morton, IL (US); Gregory J. Kaufmann, Metamora, IL (US); Mark S. Diekevers, Germantown Hills, IL (US)

(73) Assignee: Caterpillar Inc., Peoria, IL (US)

(21) Appl. No.: 14/734,127

(22) Filed: Jun. 9, 2015

(51) Int. Cl. B62D 55/21

(52) U.S. Cl. CPC B62D 55/21

(57) ABSTRACT

A link for a track assembly for a machine is provided. The link includes a link body defining an aperture configured to receive a track pin therein. The link body further includes a first surface configured to contact a rotatable element of the track assembly and a second surface configured to contact a track shoe coupled to the link body. The link further includes a plurality of markings defined on the link body proximal to the first surface. Each of the plurality of markings is indicative of a progressive wear of the link body with respect to the first surface.

### TECHNICAL FIELD

The present disclosure relates to a link for a track assembly for a machine.

### BACKGROUND

Machines are used to perform various operations in different industries, such as construction, mining, transportation, and the like. Such machines may include an upper frame supported on an undercarriage. The undercarriage includes ground engaging members which provide propulsion to the machine. Operation of the machines may result in wear to various components of the undercarriage including the ground engaging members. For example, if the undercarriage includes a track assembly as a ground engaging member, each track link of the track assembly may undergo wear due to contact with other components of the track assembly and/or a ground surface.

Such components, which are prone to wear, may be periodically inspected to determine whether the components require repair or replacement. However, periodic inspections may result in machine downtimes. Further, timely identification of wear of the components may not be possible leading to further damage and/or potential failures of the components during operation of the machine.

US Patent Publication 2015/0042152 (the '152 publication) describes an endless track for traction of a vehicle. The endless track for traction of an off-road vehicle (e.g., an agricultural vehicle, an industrial vehicle, a construction vehicle, or a military vehicle) includes an elastomeric belt-shaped body having an inner surface for facing wheels of the vehicle and a ground-engaging outer surface. The endless track also includes elastomeric lugs, such as drive/guide lugs projecting from the inner surface and/or traction lugs projecting from the ground-engaging outer surface. The elastomeric lug may have a material defining an arrangement of zones of different materials (e.g., different elastomeric materials) to exhibit a desired variation of a material property (e.g., a modulus of elasticity) across the arrangement of zones of different materials. A zone of the elastomeric lug may have a dedicated function, such as a wear indicator zone. An elastomeric drive lug can include an uneven drive surface for engaging a drive member of a drive wheel. However, the elastomeric lug, as disclosed by the '152 publication, is a separate component, thereby increasing cost and manufacturing complexity of the endless track.

### SUMMARY OF THE DISCLOSURE

In one aspect of the present disclosure, a link for a track assembly for a machine is provided. The link includes a link body defining an aperture configured to receive a track pin therein. The link body further includes a first surface configured to contact a rotatable element of the track assembly and a second surface configured to contact a track shoe coupled to the link body. The link further includes a plurality of markings defined on the link body proximal to the first surface. Each of the plurality of markings is indicative of a progressive wear of the link body with respect to the first surface.

Other features and aspects of this disclosure will be apparent from the following description and the accompanying drawings.

### BRIEF DESCRIPTION OF THE DRAWINGS

FIG. 1 is a side view of an exemplary machine having an undercarriage;

FIG. 2 is a partial perspective view of a track pin assembly of the undercarriage, according to an embodiment of the present disclosure;

FIG. 3 is a partial perspective view of a link of the track pin assembly, according to an embodiment of the present disclosure;

FIG. 4 illustrates the link of FIG. 4 in a worn condition;

FIG. 5 is a partial perspective view of the link of the track pin assembly, according to another embodiment of the present disclosure; and

FIG. 6 is a partial perspective view of the link of the track pin assembly, according to yet another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

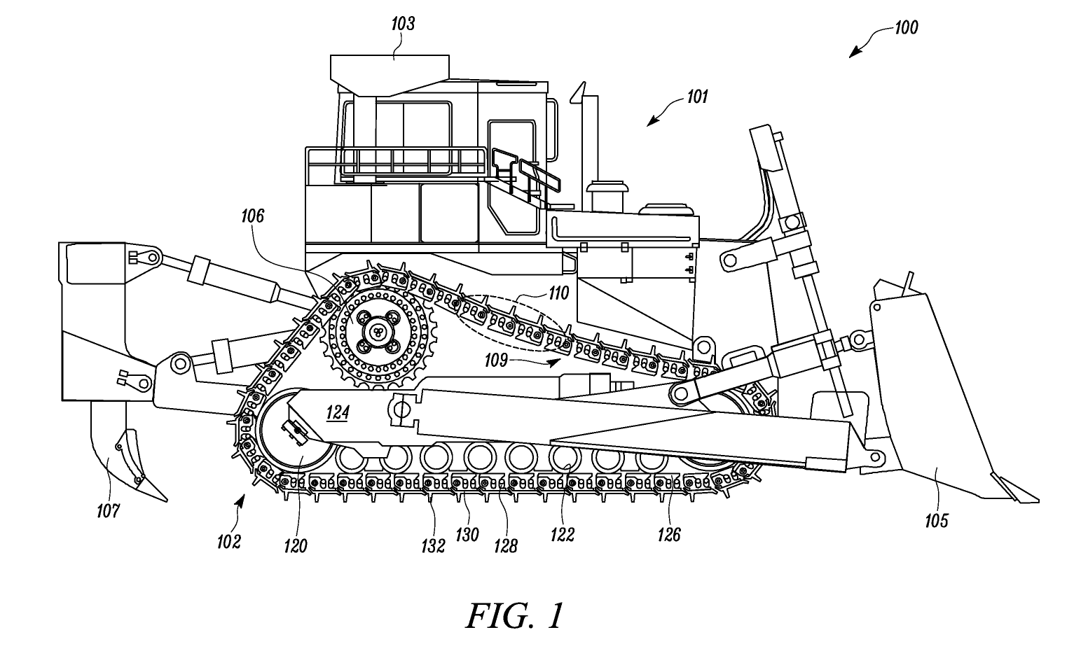

FIG. 1 illustrates an exemplary machine 100. The machine 100 includes an upper body 101 supported by an undercarriage 102. The upper body 101 includes an operator cabin 103. Further, a power source (not shown), such as an engine, may be disposed in the upper body 101. The power source may be configured to generate power to propel the machine 100, and operate a first implement 105 and a second implement 107 of the machine 100. In the illustrated embodiment, the machine 100 is a track-type tractor. Further, the first and second implements 105, 107 are a blade assembly and a ripper, respectively. However, the concepts of the present disclosure may be embodied in any type of machine having an undercarriage assembly 102, for example, skid steers, dozers, excavators, backhoes, track loaders, and the like.

The undercarriage 102 includes a pair of track assemblies 109 (only one shown) on opposing sides of the machine 100. The track assembly 109 includes a track 110, a drive sprocket 106, at least one idler 120, multiple rollers 122, and a frame assembly 124. The track 110 may form a continuous structure operatively coupled to the drive sprocket 106, the idlers 120, and the rollers 122. Further, the power source of the machine 100 may transmit power to the drive sprocket 106 via a driving mechanism. The driving mechanism may include a mechanical drive, a hydraulic drive, an electric drive, or a combination thereof

The frame assembly 124 may carry the idlers 120. The frame assembly 124 may include multiple members (not shown) longitudinally movable relative to one another. During operation, a relative movement between the members of the frame assembly 124 may move the idlers 120 relative to one another. Further, rotation of the drive sprocket 106 may cause the track 110 to move around the drive sprocket 106, the idlers 120, and the rollers 122 and engage a ground surface, and thereby propel the machine 100. The drive sprocket 106 may be driven in different directions to propel the machine 100 in forward or reverse directions. Further, the machine 100 may be steered by providing differential power to the drive sprockets 106 of the corresponding track assemblies 109.

In the illustrated embodiment, the track 110 includes a plurality of interconnected links 126. Adjacent links 126 may be rotatably coupled together via a track pin assembly 128. The track pin assembly 128 may be engaged by teeth of the drive sprocket 106 to drive the track 110 around the drive sprocket 106, the idlers 120, and the rollers 122.

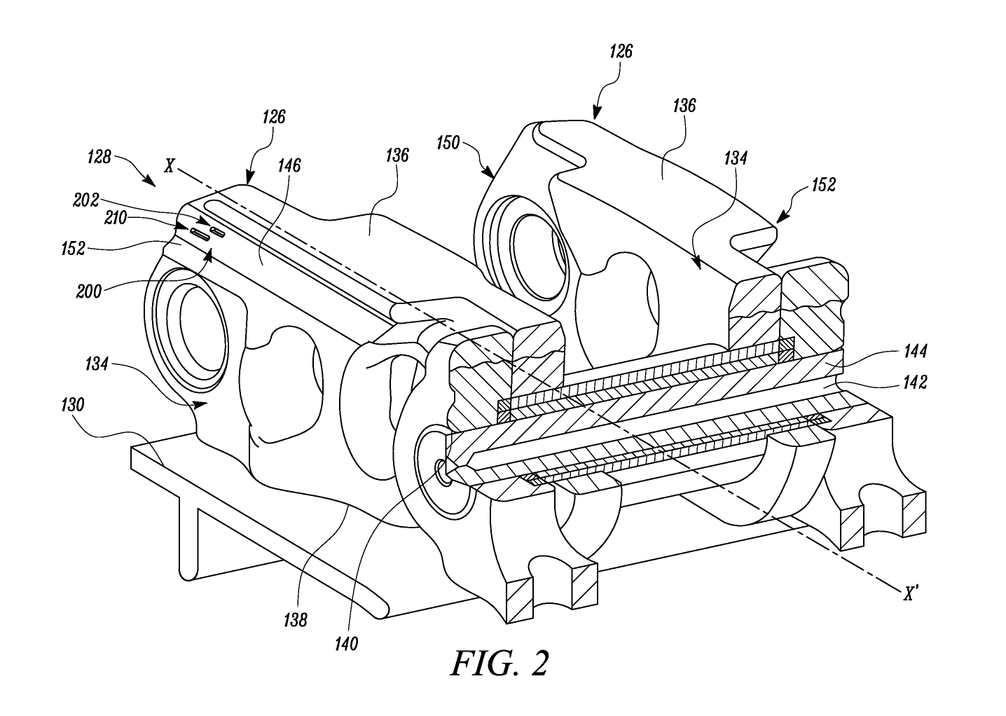

Referring to FIGS. 1 and 2, the track 110 further includes multiple track shoes 130 secured to the links 126. In the illustrated embodiment, each of the track shoes 130 is secured to two links 126. Each of the track shoes 130 includes a connecting portion (not shown) configured to be secured to one or more of the links 126 and a ground engaging portion 132 configured to contact the ground. The ground engaging portion 132 may include one or more portions (e.g., grouser bars) that provide increased traction between the track shoes 130 and the ground. It should be understood that the various components of the undercarriage 102, described above, are purely exemplary and not intended to be limiting of the present disclosure.

FIG. 2 illustrates a track pin assembly 128 of the undercarriage 102. The track pin assembly 128 is configured to couple the two adjacent links 126. The track pin assembly 128 includes a track pin 142 and a bushing 144. The track pins 142 pivotally couple the adjacent links 126.

Each of the links 126 further includes a link body 134. The link body 134 defines a longitudinal axis XX′ extending between a first end 160 of the link body 134 and a second end 162 of the link body 134. Each of the link bodies 134 includes a first surface 136 and a second surface 138 distal to the first surface 136. The first surface 136 is configured to contact a rotatable element of the track assembly 109. In the illustrated embodiment, the first surface 136 is configured to contact the idlers 120 and the rollers 122 of the track assembly 109. The second surface 138 is configured to contact the track shoes 130. The link body 134 further defines an aperture 140 configured to receive the track pin 142 therein. The link 126 further includes an inboard side 150 and an outboard side 152.

During operation, the first surface 136 of the links body 134 may undergo wear due to abrasion. As a threshold wear limit “L” of the link body 134 is reached, the links 126 may require replacement and/or repair. The threshold wear limit “L” may correspond to a maximum wear sustained by the link body 134 left after which the link body 134 requires replacement and/or repair.

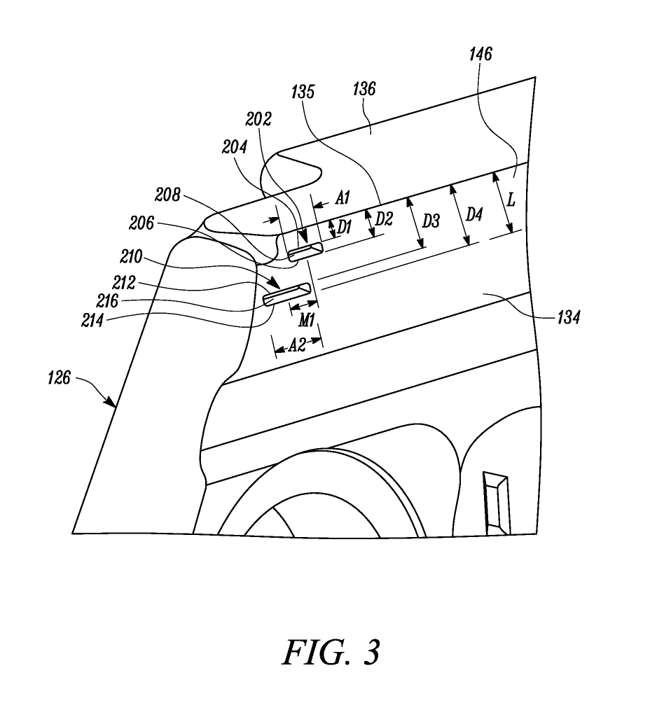

Referring to FIG. 3, the link 126 further includes a plurality of markings 200 defined on the link body 134 proximal to the first surface 136. The markings 200 are defined on the outboard side 152 of the link body 134. However, the markings 200 may be defined on any side of the link body 134 such that the markings 200 are easily visible to a user. Each of the markings 200 is indicative of a progressive wear of the link body 134 with respect to the first surface 136. In an example, the markings 200 may provide a quantitative measure of a degree of wear of the link body 134 with respect to the wear limit “L”. In an example, the markings 200 may correspond to a number of depressions defined on an outboard surface 146 of the outboard side 152 of the link body 134. In an alternate embodiment, the markings 200 may be through holes communicating between the inboard side 150 and the outboard side 152. However, the link 126 may also include one or more color markings, letter markings or a combination thereof.

In the illustrated embodiment, each of the links 126 includes a first marking 202 proximal to the first surface 136. The first marking 202 includes an upper edge 204 and a lower edge 206 defining a first portion 208 therebetween. The first portion 208 may be a depression defined on the outboard surface 146 of the link body 134. However, in an alternate embodiment, the second portion 216 may be filled with color markings different from a color of the link body 134. The upper edge 204 is positioned at a distance “D1” from a surface edge 135 of the first surface 136. The distance “D1” may be determined based on a first predetermined percentage of wear with respect to the wear limit “L” of the link body 134. In an embodiment, the first predetermined percentage of wear may be 50% of the wear limit “L”. Further, one or more indicia (not shown) may be provided adjacent to the upper edge 204 to indicate a value of the first predetermined percentage of wear. Further, the lower edge 206 of the first marking 202 is positioned at a distance “D2” from the surface edge 135 of the first surface 136. The distance “D2” may be determined based on a second predetermined percentage of wear with respect to the wear limit “L” of the link body. In an embodiment, the second predetermined percentage of wear may be 60% of the wear limit “L”. Further, one or more indicia (not shown) may be provided adjacent to the lower edge 206 to indicate a value of the second predetermined percentage of wear.

The link 126 further includes a second marking 210 distal to the first surface 136. The second marking 210 includes a top edge 212 and a bottom edge 214 defining a second portion 216 therebetween. In the illustrated embodiment, the second portion 216 is a depression defined on the outboard surface 146 of the link 126. However, in an alternate embodiment, the second portion 216 may be filled with color markings different from a color of the link body 134. The top edge 212 is positioned at a distance “D3” from the surface edge 135 of the first surface 136. The distance “D3” may be determined based on a third predetermined percentage of wear with respect to the wear limit “L” of the link body 134. In an embodiment, the third predetermined percentage of wear may be 90% of the wear limit “L”. Further, one or more indicia (not shown) may be provided adjacent to the top edge 212 to indicate a value of the third predetermined percentage of wear. Further, the bottom edge 214 of the second marking 210 is positioned at a distance “D4” from the surface edge 135 of the first surface 136. The distance “D4” may be determined based on a fourth predetermined percentage of wear with respect to the wear limit “L” of the link body 134. In an embodiment, the fourth predetermined percentage of wear corresponds to the wear limit “L”. Further, one or more indicia (not shown) may be provided adjacent to the bottom edge 214 to indicate a value of the fourth predetermined percentage of wear.

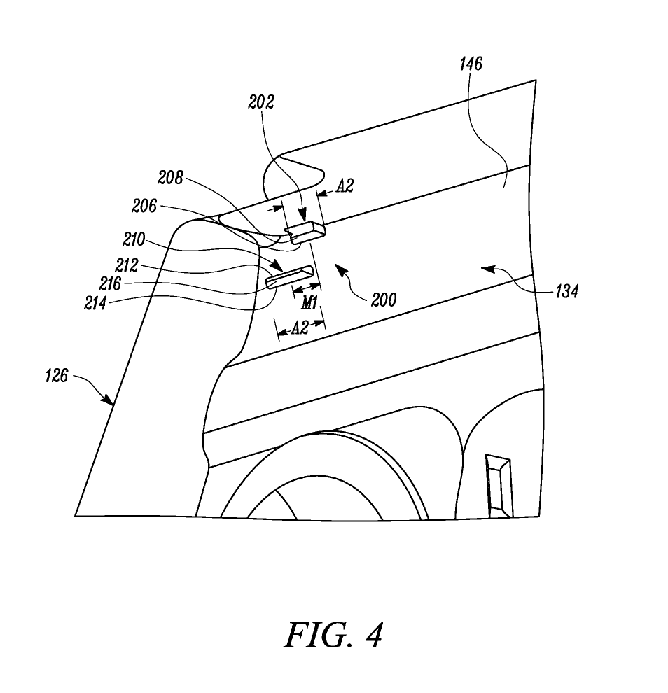

FIG. 4 illustrates the link 126 of FIG. 4 in a worn condition, the first surface 136 of the link body 134 is worn out to the first marking 202. This indicates that the link body 134 is worn to the first predetermined percentage of wear with respect to the wear limit “L”. It may alert a user of a remaining time period before which the link body 134 requires replacement and/or repair.

Referring to FIGS. 3 and 4, the markings 200 are substantially rectangular in shape. In various alternative embodiments, the first and second portions 208, 216 may be circular, oval, elliptical or any suitable shape. Further, the first and second markings 202, 210 are disposed along the longitudinal axis XX′. However, each of the first and second markings 202, 210 may be disposed at a corresponding angle with respect to the longitudinal axis XX′. Further, in the illustrated embodiment, the markings 200 are laterally offset with respect to each another by a distance“M1”. However, in an alternate embodiment, the markings 200 may be vertically aligned. The first marking 202 extends to a length “A1” along the longitudinal axis XX′. The second marking 210 further extends to a length “A2” along the longitudinal axis XX′. In an example, the length “A1” may be substantially equal to the length “A2” of the second marking 210.

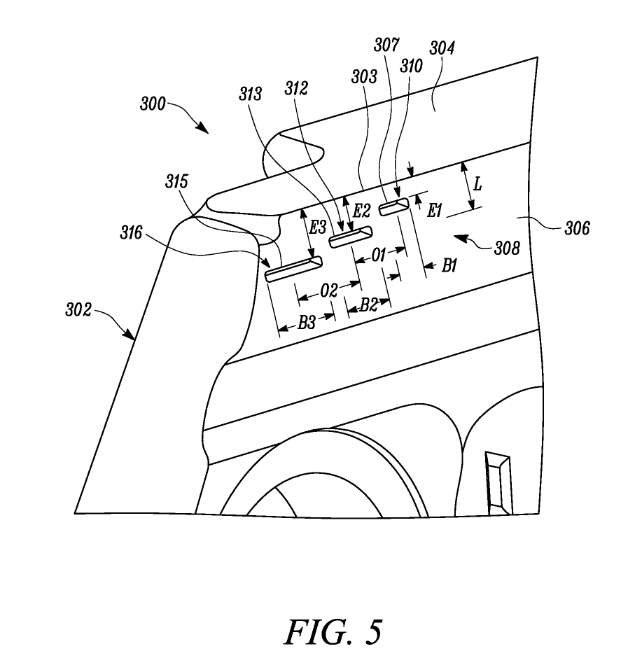

FIG. 5 illustrates a partial perspective view of the link 300 of the track pin assembly 109, according to another embodiment of the disclosure. The link 300 includes a link body 302 and a first surface 304 configured to contact a rotatable element of the track assembly 109. The link 300 includes a plurality of markings 308. In the illustrated embodiment, the markings 308 are depressions defined on an outboard surface 306. The link body 302 includes a first marking 310 defined on the outboard surface 306 of the link body 302. The first marking 310 is positioned at a predetermined distance “E1” from a surface edge 303 of the first surface 304. The distance “E1” may be determined based on a first predetermined percentage of wear with respect to the wear limit “L” of the link body 302. In an embodiment, the first predetermined percentage of wear may be 50% of the wear limit “L”. Further, one or more indicia (not shown) may be provided adjacent to a first edge 307 of the first marking 310 to indicate a value of the first predetermined percentage of wear. The link 300 further includes a second marking 312 defined on the outboard surface 306 of the link body 302. The second marking 312 is positioned at a predetermined distance “E2” from the surface edge 303 of the first surface 304. The distance “E2” may be determined based on a second predetermined percentage of wear with respect to the wear limit “L” of the link body 302. In an embodiment, the second predetermined percentage of wear may be 50% of the wear limit “L”. Further, one or more indicia (not shown) may be provided adjacent to a second edge 313 to indicate a value of the second predetermined percentage of wear.

The link 300 further includes a third marking 316 defined on the outboard surface 306 of the link body 302. The third marking 316 is positioned at a predetermined distance “E3” from the surface edge 303 of the first surface 304. The distance “E3” may be determined based on a third predetermined percentage of wear with respect to the wear limit “L” of the link body 302. In an embodiment, the third predetermined percentage of wear may correspond to the wear limit “L”. Further, one or more indicia (not shown) may be provided adjacent to a third edge 315 to indicate a value of the third predetermined percentage of wear. In the illustrated embodiment, the first and second markings 310, 312 are laterally offset with each other by a distance “O1”. Further, the second and third markings 312, 316 are laterally offset by a distance “O2”. In an example, the distances “O1” and “O2” may be substantially equal. However, in an alternate embodiment, the markings 308 may be vertically aligned. Further, the first, second, and third markings 310, 312, and 316 extend to lengths “B1”, “B2”, and B3 respectively along the longitudinal axis XX′. In an example, the lengths “B1”, “B2”, and “B3” may be substantially equal to each other.

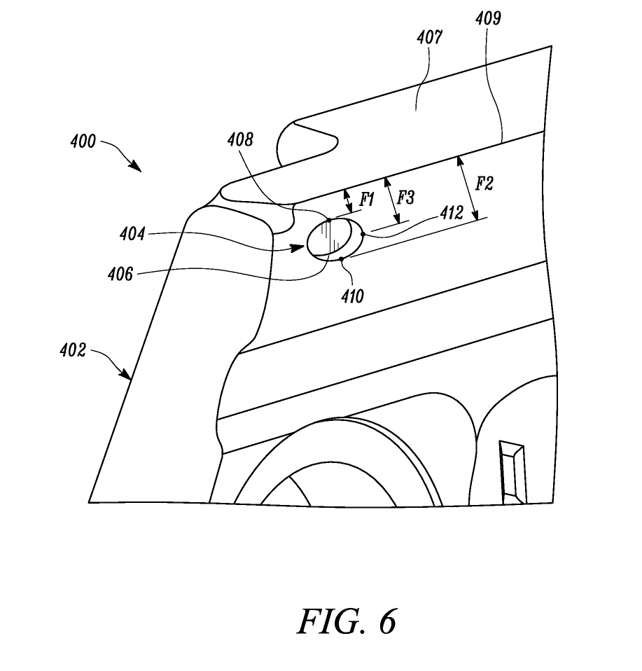

FIG. 6 is a partial perspective view of a link 400 of a track pin assembly 109, according to yet another embodiment of the present disclosure. The link 400 includes a link body 402 and a first surface 407 configured to contact a rotatable element of the track assembly 109. The link 400 includes a plurality of markings 404 defined on the link body 402 proximal to the first surface 407. The link body 402 further includes a first surface 407 configured to contact a rotatable element of the track assembly 109. The markings 404 are disposed around a depression 406 defined on an outboard surface 405 of the link body 402. In the illustrated embodiment, the depression 406 is circular. However, in alternative embodiments, the depression 406 may be elliptical, oval, or any suitable curvilinear shape. The markings 404 include a first point 408 proximal to the first surface 407, a second point 410 radially opposite to the first point 408 , and a third point 412 disposed between the first and second points 408, 410. The first point 408 is positioned at a predetermined distance “F1” from a surface edge 409 of the first surface 407. The distance “F1” may be determined based on a first predetermined percentage of wear with respect to the wear limit “L” of the link body 402. In an embodiment, the first predetermined percentage of wear may be 50% of the wear limit “L”. Further, one or more indicia (not shown) may be provided adjacent to the first point 408 to indicate a value of the first predetermined percentage of wear. The second point 410 is further positioned at a predetermined distance “F2” from the surface edge 409 of the first surface 407. The distance “F2” may be determined based on a second predetermined percentage of wear with respect to the wear limit “L” of the link body 402. In an embodiment, the second predetermined percentage of wear may correspond to the wear limit “L”. Further, one or more indicia (not shown) may be provided adjacent to the second point 410 to indicate a value of the second predetermined percentage of wear. The third point 412 is further positioned at a predetermined distance “E3” from the surface edge 409 of the first surface 407. The distance “F3” may be determined based on a third predetermined percentage of wear with respect to the wear limit “L” of the link body 402. In an embodiment, the third predetermined percentage of wear may be 75% of the wear limit “L”. Further, one or more indicia (not shown) may be provided adjacent to the third point 412 to indicate a value of the third predetermined percentage of wear.

### INDUSTRIAL APPLICABILITY

The present disclosure is related to the links 126, 300, and 400 for the track assembly 109 for the machine 100. Each of the links 126, 300 and 400 includes markings 200, 308, and 404 defined on a corresponding link body proximal to a corresponding first surface. Such links 126, 300, and 400 with the markings 200, 308, and 404 may be manufactured by a process such as casting, forging or the like. Since the markings 200, 308, and 404 are provided on a corresponding link body during manufacture thereof, any additional components or system are not required for wear monitoring. Each of the markings 200, 308, and 404 is indicative of a progressive wear of the link body with respect to the first surface. The markings 200, 308, and 404 may enable monitoring of wear of the link. Extent of wear may indicate whether the links 126, 300, and 400 require repair and/or replacement. Further, the markings 200, 308, and 404 may provide an indication if the links 126, 300, and 400 require immediate attention, thereby preventing any possible failures of the undercarriage components. Hence, machine downtimes may be reduced.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A link for a track assembly for a machine, the link comprising:
a link body defining an aperture configured to receive a track pin therein, the link body further comprising a first surface configured to contact a rotatable element of the track assembly and a second surface configured to contact a track shoe coupled to the link body; and
a plurality of markings defined on the link body proximal to the first surface, each of the plurality of markings being indicative of a progressive wear of the link body with respect to the first surface.
